(19) United States
(12) Patent Application Publication
(10) Pub. No.: US 2023/0021656 A1
(43) Pub. Date: Jan. 26, 2023

(54) RADAR SENSOR HAVING A WAVEGUIDE STRUCTURE

(71) Applicant: Robert Bosch GmbH, Stuttgart (DE)

(72) Inventors: Christian Hollaender, Waldbronn (DE); Gustav Klett, Moessingen (DE); Klaus Voigtlaender, Wangen (DE); Klaus Baur, Mietingen (DE)

(21) Appl. No.: 17/812,248

(22) Filed: Jul. 13, 2022

(30) Foreign Application Priority Data
Jul. 22, 2021 (DE) 10 2021 207 896.6

(51) Int. Cl. H01P 5/107; H01Q 1/32; H01P 11/00

(52) U.S. Cl. CPC H01P 5/107; H01Q 1/3233; H01P 11/002; G01S 13/931

(57) ABSTRACT

A radar sensor having at least one high-frequency component and at least one waveguide structure in the form of a plastic body provided with an electrically conductive surface layer. The radar sensor has at least one further plastic body provided with an electrically conductive surface layer, and the plastic bodies with their conductive surface layers are thermally bonded to one another.

### CROSS REFERENCE

The present application claims the benefit under 35 U.S.C. § 119 of German Patent Application No. DE 10 2021 207 896.6 filed on Jul. 22, 2021, which is expressly incorporated herein by reference in its entirety.

### FIELD

The present invention relates to a radar sensor having at least one high-frequency component and at least one waveguide structure in the form of a plastic body provided with an electrically conductive surface layer.

More specifically, the present invention relates to radar sensors which are used in motor vehicles for sensing the traffic environment such as within the framework of driver-assistance systems, collision warning systems or autonomous driving systems. These radar sensors typically operate in a frequency band at 77 GHz.

### BACKGROUND INFORMATION

While antennas that are formed out of a microwave substrate are used in many conventional radar sensors, the present invention relates to radar sensors in which the antennas are formed by waveguide structures. One example of a radar sensor of this type is described in German Patent Application No. DE 10 2018 203 106 A1.

### SUMMARY

It is an object of the present invention to provide a radar sensor of this type which is able to be produced in a more economical manner.

According to the present invention, this object may be achieved in that the radar sensor has at least one further plastic body provided with an electrically conductive surface layer, and the plastic bodies with their conductive surface layers are thermally bonded to each other.

“Thermal bonding” in the sense of this application is to be understood as a process in which the components are connected to one another in a planar manner by means of heat under temporary fusing of the material, e.g., by soldering or welding. This implies that the plastic bodies are made of plastic materials that have sufficient thermal stability.

In conventional waveguide structures made of plastic, the electrically conductive layer is formed by lacquering the inner surfaces of the hollow spaces of the waveguide structure, by a vapor-deposition, sputtering or galvanizing, for instance. In the radar sensor according to the present invention, the plastic bodies also have a conductive surface layer on at least one outer surface so that they are able to be mechanically and electrically connected to each other in a secure manner and at the same time by a soldering or welding process. The conductive surface layers required for this purpose can be efficiently produced in the same process that is also used for producing the conductive surface layers on the inner walls of the cavities.

The waveguide structure may be a waveguide antenna or part of a waveguide antenna. The at least one further plastic body can be a further waveguide antenna or a waveguide distributor structure for the microwave power or it may also be a plastic body that is used for centering, protecting and/or for electronically connecting the high-frequency component. According to the present invention, all of these components are able to be connected to one another in an efficient and economical manner. It is also advantageous that the thermal bonding allows for microwave-tight sealing of the waveguide structures and for achieving slight high-frequency damping of the involved components. The production of the components from plastic, e.g., by injection molding, injection stamping or extrusion or possibly also partly by material-removing machining, allows for a high measure of design freedom.

Advantageous embodiments and further refinements of the present invention are disclosed herein.

The electrically conductive layers may be metallized surface layers. In a further embodiment, the conductive surface layers are formed by layers of plastic materials, which include special filler materials such as CuSn, Fe, Cu, SnZn, for instance, which make the plastic electrically conductive and solderable at the same time.

The radar sensor may have more than two plastic bodies, which are joined to one another in a single solder or welding process. In the same solder or welding process, the connection of the high-frequency component, e.g., a MMIC chip (Monolithic Microwave Integrated Circuit) or an RF-CMOS chip, to the waveguide structures may also take place.

In the following text, exemplary embodiments of the present invention will be described in greater detail with the aid of the figures.

### BRIEF DESCRIPTION OF THE DRAWINGS

FIG. 1 shows a schematic section through a radar sensor according to an example embodiment of the present invention.

FIG. 2 shows a perspective exploded representation of three plastic bodies, which are part of the radar sensor, in an oblique view from above.

FIG. 3 shows an exploded representation of the plastic bodies according to FIG. 2 in an oblique view from below.

### DETAILED DESCRIPTION OF EXAMPLE EMBODIMENT

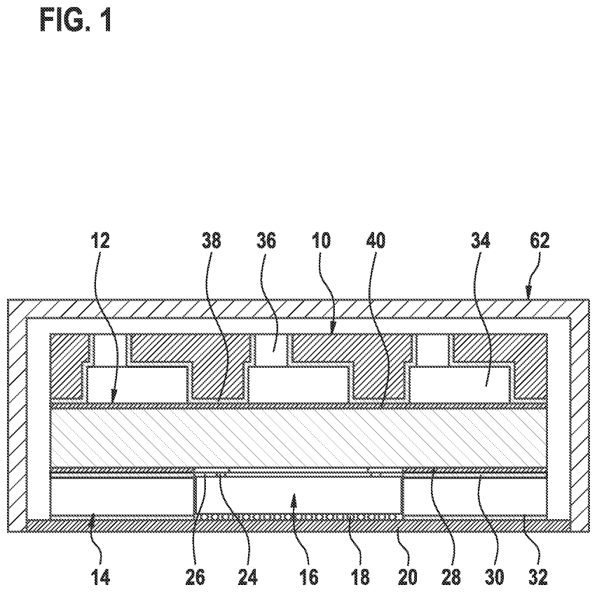

The radar sensor shown in FIG. 1 has a total of three plate-shaped plastic bodies stacked on top of one another, which—in a sequence from top to bottom in FIG. 1—form a first waveguide structure 10, a second waveguide structure 12, and a centering body 14 for a high-frequency component 16. High-frequency component 16, e.g., an MMIC chip, is electrically and mechanically connected to a circuit board 20 by an array of solder contacts 18, e.g., what is known as a ball grid, circuit board 20 including the electronic components (not shown in greater detail) for the actuation of the MMIC and for the further evaluation of the receive signals pre-evaluated in the MMIC.

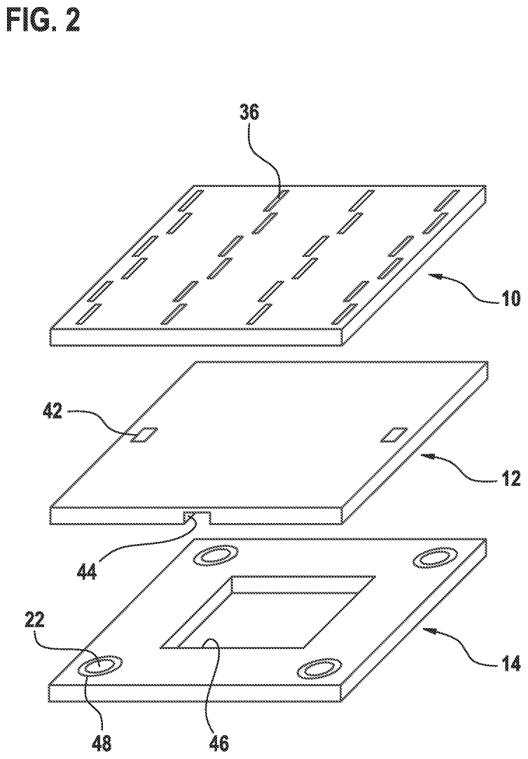

Centering body 14, which surrounds high-frequency component 16 like a frame, has vias 22 (not visible in FIG. 1, but visible in FIG. 2), which make it possible to electrically connect also second waveguide structure 12 to circuit board 20 and to transmit signals between the circuit board and contacts 24 that are formed on the topside of the high-frequency component. To this end, special conductor tracks 26 are formed on the underside of second waveguide structure 12. In the zones outside these conductor tracks, second waveguide structure 12 has on the underside an electrically conductive surface layer 28, which is soldered in a planar manner to an electrically conductive surface layer 30 at the topside of centering body 14. A further electrically conductive surface layer 32 on the underside of centering body 14 is soldered to a ground electrode (not shown in greater detail) of circuit board 20. Surface layers 30 and 32 are electrically connected in a suitable manner, e.g., by surface layers, at the edges of the centering body.

First waveguide structure 10 forms a first waveguide antenna having a plurality of parallel waveguides 34, which are open in the direction of the topside of the waveguide structure via a field of radiation orifices 36 in each case. The inner walls of waveguides 34 and radiation orifices 36 are formed by an electrically conductive surface layer 38. This surface layer 38 is also formed on the underside of waveguide structure 10 and soldered there in a planar manner to a further conductive surface layer 40 at the topside of second waveguide structure 12.

The second waveguide structure forms waveguides 42 (FIG. 2) for the connection of first waveguide structure 10. At the same time, second waveguide structure 12 forms a second waveguide antenna provided with radiation orifices 44 on the side. The walls of waveguides 42 and radiation orifices 44 likewise have conductive surface layers which connect surface layers 40 and 28 on the topside and the underside of second waveguide structure 12 to one another in a conductive manner. In this way, all conductive surface layers of all three plastic bodies are electrically connected to one another and to the ground electrode on circuit board 20.

As illustrated in FIG. 2, centering body 14 has a square orifice 46 in the center, which accommodates semiconductor component 16 (not shown in FIG. 2) with a precise fit so that waveguide structures 10, 12 and high-frequency component 16 are precisely alignable with one another.

Vias 22 are situated in the corners of centering body 14 and surrounded by an annular, nonconductive zone 48, which separates the via from surface layer 28 situated at the ground potential.

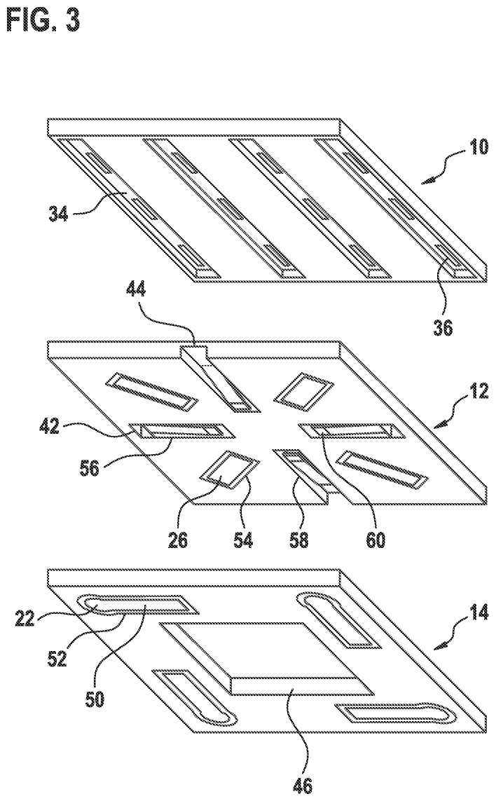

In FIG. 3, the undersides of waveguide structures 10, 12 and centering body 14 can be seen. At the underside of centering body 14, vias 22 transition to conductor tracks 50, which lead to corresponding signal electrodes and voltage supply electrodes on circuit board 20 and are separated from surface layer 30 by a nonconductive zone 52.

Visible on the underside of second waveguide structure 12 are diagonally extending conductor tracks 26, which connect one of vias 22 to one of contacts 24 of high-frequency component 16. Conductor tracks 26 are also separated from conductive surface layer 28 by nonconductive zones 54.

In addition, second waveguide structure 12 has waveguides 56, 58 on the underside, which are connected to high-frequency component 16 via a high-frequency interface 60. Waveguides 56 lead to one of waveguides 42 in each case for the connection of first waveguide structure 10, and waveguides 58 lead to one of radiation orifices 44 of the second waveguide antenna in each case.

Visible on the underside of first waveguide structure 10 are waveguides 34 and the inner ends of radiation orifices 36.

As shown in FIG. 1, waveguide structures 10, 12, centering body 14 and high-frequency component 16 are accommodated in a housing 62 whose upper wall forms a radome of the radar sensor, which has a defined clearance from radiation orifices 36 and is made of a plastic material permeable to microwave radiation.

In the production of the afore-described radar sensor, it is possible to proceed in such a way that, for instance, the particular surface regions meant to form the nonconductive zones 48, 52 and 54 are initially covered in a suitable manner (e.g., pad printing, cover plates, cover foil), and the conductive surface layers are then formed on waveguide structure 12 and centering body 14, whereupon the covers are removed again. In another embodiment, the conductive surface layers may also have an uninterrupted development and the nonconductive zones can be formed by subsequently removing the conductive surface material in these zones with the aid of laser ablation.

First waveguide structure 10 is provided with conductive surface layer 40. Next, a suitable solder is applied to the surfaces to be soldered together, the two waveguide structures 10, 12, centering body 14 and semiconductor component 16 are joined to form a unit in the manner illustrated in FIG. 1, temporarily held together and then soldered together in one working step. In a further step, the thereby obtained unit will then be soldered onto circuit board 20.

As an alternative, it is also possible to proceed in such a way that high-frequency component 16 is first placed on circuit board 20, centering body 14, second waveguide structure 12 and first waveguide structure 10 are then applied one after the other, the components are centered, and all components including circuit board 20 are then soldered together in a single solder step.

Next, housing 62 is mounted separately in a final working step in each case. The radome, that is, the upper wall of housing 62, for example, may optionally also be held at a defined distance from radiation orifices 36 with the aid of suitable spacers, e.g., by fins on the topside of the plastic body which forms first waveguide structure 10.

What is claimed is:

1. A radar sensor, comprising:
at least one high-frequency component;
at least one waveguide structure in the form of a plastic body provided with an electrically conductive surface layer; and
at least one further plastic body provided with an electrically conductive surface layer;
wherein the plastic body and the at least one further plastic body with their conductive surface layers are thermally bonded to one another.

2. The radar sensor as recited in claim 1, wherein the plastic body and the at least one further plastic body are soldered together.

3. The radar sensor as recited in claim 1, wherein the conductive surface layer of the plastic body and the conductive surface layer of the at least one further plastic body are made of a thermally stable and electrically conductive plastic.

4. The radar sensor as recited in claim 1, wherein the at least one waveguide structure is a waveguide antenna.

5. The radar sensor as recited in claim 4, wherein the at least one further plastic body is a further waveguide structure.

6. The radar sensor as recited in claim 5, wherein the further waveguide structure forms a further waveguide antenna.

7. The radar sensor as recited in claim 5, wherein the further waveguide structure has waveguides for connection of a waveguide antenna to the high-frequency component.

8. The radar sensor as recited in claim 1, wherein the at least one further plastic body is a centering body configured to center the high-frequency component relative to the waveguide structure.

9. The radar sensor as recited in claim 8, wherein the centering body is bonded via an electrically conductive surface layer to a ground electrode of a circuit board, which carries the high-frequency component.

10. The radar sensor as recited in claim 9, wherein the centering body is a plate-shaped body which is provided on both sides with conductive surface layers, which are electrically connected to one another.

11. The radar sensor as recited in claim 10, wherein conductive surface layers of all waveguide structures are connected via the centering body to the ground electrode of the circuit board.

12. The radar sensor as recited in claim 9, wherein the centering body has vias for connecting contacts of the circuit board to conductor tracks of a waveguide structure that lead to contacts of the high-frequency component.
